(19) United States
(12) Patent Application Publication
(10) Pub. No.: US 2004/0042796 A1
(43) Pub. Date: Mar. 4, 2004

(54) Photonic communication system with "sub-line rate" bandwidth granularity, protocol transparency and deterministic mesh connectivity

(76) Inventors: Cedric Con-Carolis, North Gower (CA); Peter McLlroy, Ottawa (CA); Edward Ryszard Sokolowski, Kanata (CA)

Correspondence Address: Welsh & Katz, Ltd., 22nd Floor, 120 South Riverside Plaza, Chicago, IL, 60606, US

(21) Appl. No.: 10/655,209

(22) Filed: Sep. 4, 2003

Related U.S. Application Data
(63) Continuation of application No. PCT/CA02/00301, filed on Mar. 6, 2002.

(30) Foreign Application Priority Data
Mar. 7, 2001 (CA) 2,339,902

(51) Int. Cl. H04J 14/02

(52) U.S. Cl. 398/83; 398/75

(57) ABSTRACT

The system and method are used for transparently transporting a multiplicity of data formats (TDM, frame, packet, cell, etc.) and bit rates in a deterministic manner over an optical telecommunications network facilitates purely photonic aggregation, separation and switching of granular, sub-wavelength capacity of bandwidths less than the line rate capacity. The sub-rate of the optical transport on a given optical frequency between network edge components uses time-slot based TDM channels that can be optically bursted across different wavelengths using wavelength hopping to allow all-optical switching of the channels between different signal paths in the optical switch nodes, on a time-slot-by-time slot basis using WDM to reduce the probability of blocked connections. The connection management of these wavelength hopping optical TDM burst, (referred to as waveslots herein) is done using a connection protocol that employs conventional “least cost” path calculation algorithms to identify target connection routing through the optical network. A path integrity process ensures capacity, link removal and recalculation in cases of blocked connections. The time slot and wavelength map can be represented as a two dimensional matrix. Availability calculations can be done using simple matrix logic operations. The capability of the network to reconfigure and rearrange itself is maximized by the use of wavelength hopping. A full optical connection oriented bandwidth mechanism for management of that granular capacity is provided.

### BACKGROUND OF THE INVENTION

1. Field of the Invention

The present invention relates generally to telecommunications networks that have a plurality of nodes interconnected by an optical transmission medium, and particularly to self-healing optical single and multiple wavelength networks with hubbed, meshed or mixed connectivity. More particularly, it relates to such networks with “sub-line rate” bandwidth granularity, protocol transparency and deterministic mesh connectivity.

2. Prior Art of the Invention

Today's telecommunications networks typically consist of access networks that connect end-users, also referred to herein as clients, to the network and transport networks that provide the interconnection between the access networks. The transport networks can be further separated into metro, regional inter-office facilities (IOF), also refereed to as metro core, and a backbone or core portions.

The access networks are under pressure to increase the variety of supported protocols to support emerging services, which typically require higher bit-rates, such as private-line Ethernet(™). The transport network in-turn, are under pressure to provide more capacity and switching flexibility to support the increase in capacity coming from the access networks.

Optical telecommunications networks are currently the predominant architecture for transport networks to connect optical nodes to transfer voice, text, data, video information etc., referred to herein as traffic; more specifically including a variety of optical network topologies, such as point-to-point, linear add-drop, ring and mesh optical networks. In the event of a failure re-routing of traffic towards the opposite direction is done using spare capacity, lower priority capacity or dedicated protection capacity.

Currently, the key standard for conventional optical networks is time division multiplex (TDM) based SONET/SDH (Synchronous Optical Network/Synchronous Digital Hierarchy). SONET was developed to provide a survivable transport infrastructure for a wide variety of traffic protocols and bit rates. The SONET/SDH standard defined a hierarchy of optical transmission rates—optical carrier (OC) level for SONET and synchronous transport mode (STM) for SDH. For example, SONET optical carrier-level 3 (OC-3) transmits at 155 Mb/s, while SDH synchronous transport mode level 1 (STM-1) transmits at 155 Mb/s, over different network topologies.

In order for SONET/SDH to carry a range of traffic protocols and bit rates, referred to also as payload protocols and payload bit rates, SONET/SDH defines a payload “envelope” into which all pre-defined SONET/SDH supported payloads must be mapped. This envelope comprises timeslots for the traffic information and the overhead information to manage that traffic. This provides SONET/SDH with the ability to carry a range of protocols; however, a new protocol cannot be transported until a mapping is defined so that an interface (port) circuits is developed, then verified, and then finally deployed. Even with “virtual concatenation” this approach still is the norm. If the bit-rate of the new protocol is above the capacity of the local network infrastructure then the entire local network, including all the nodes on that network may have to be upgraded.

Recently optical telecommunications networks have provided increasing capacity using wavelength division multiplexing (WDM), or dense wavelength division multiplexing (DWDM). The term “wavelength” is defined herein as an end-to-end optical channel or circuit of the same optical frequency from source to destination across an optical network. In practice wavelengths may change frequency through wavelength translation to make longer distance connections and/or to avoid wavelength blocking at intermediate nodes. Photonic communication systems which include switching nodes which route optical signals without converting the signal from optical (O) to electrical (E) signals and back to optical (O) again (OEO conversions) are soon to move from the lab to practical deployment. These systems provide substantial benefits over existing systems, in which optical signals are switched almost exclusively in the electrical domain, i.e. Canadian Patent 2,271,813, but they also have shortcomings. These systems are based on switching all the data in a given wavelength from one path to another, resulting in either inefficient transport, due to low data rates; or excessively large bandwidths being switched. A key impediment to more efficient processing of the bandwidth is the data transmission format, typically SONET or SDH, which does not lend itself to simple optical management. An alternative method being pursued is the use of optical packet switching, see Canadian Patent 2,310,856, in which, analogously with electrical packet switching, optical packets with associated routing information are transmitted and optical switches must determine the appropriate route for each packet. These systems must deal with contention for transmission resources at each node, require substantial effective bandwidth for each packet label, require extremely high speed optical switches, and require high speed processing at the nodes to determine the appropriate path through the node.

An improvement provided by the present invention is that the optical data signal is presented to the network with a format that is conducive to optical management as a connection with a rate less than or equal to the line rate, but in a format which does not require very high speed operations, pre-calculated paths simplify contention avoidance and is indifferent to the underlying protocol and bit-rate of the data traffic being transported and photonic switches are employed for fibre to fibre routing (i.e. cross-connection), which enable the bandwidth management without re-conversion back to electrical. The optical path for data through the network is established once per connection, and so all contention issues can be resolved in longer times or the connection can be disallowed, without the danger of a partial connection. The removal of both the OEO operations and the need for large bandwidth aggregation machines (i.e. Multi-Protocol Label Switching (MPLS), Asynchronous Transfer Mode (ATM) or Synchronous Transport Signal (STS) cross connects) results in substantial savings in the capital and operating costs of a photonic network.

The term “node” is defined herein as an entity comprising client ports to receive and transmit data from devices such as add-drop multiplexers (ADMs), routers, switches etc. for transporting client “data” traffic, and facility ports to deliver data traffic to and from other nodes in the network. The node also may have an optional traffic control and management unit. The optional traffic control and management unit has some or all the capabilities to transfer, multiplex and demultiplex, process, monitor, protect (1+1; 1:1; 1:N; where N is the number of working links or units that share the protection link or unit), switch or route the signals inside the node.

A “point-to-point” network is defined herein as group of entities comprising two nodes directly connected with no intermediate nodes and all the traffic begins and ends at the nodes. The physical connection is made by one or more optical fibers; called a “span”.

A fiber “span” is defined herein as a set of working and spare protection links or capacity in parallel between adjacent nodes, with single or multiple wavelengths.

A “linear chain network” is a point-to-point network, but with intermediate nodes where traffic can be dropped (received by) or added (transmitted from) at the intermediate nodes. A tree and branch topology is a variant of a linear chain network.

A “ring network” is defined herein as a group of entities comprised of uni- or bi-directionally connected nodes in a physical or logical loop with fiber spans between any two nodes, all nodes are 2-connected (i.e. each node has 2-spatially diverse routes emanating from that node, one to an upstream node and one to a downstream node), with single or multiple wavelengths, and with working and protection capacity around the ring or between two or more nodes. In the event of a failure of one of the diverse routes, spare capacity on the other route is used to restore the ring traffic affected by the failure.

The most predominant rings in today's optical telecommunications networks are path-switched Unidirectional Path-Switched Ring (UPSR) or line-switched Bi-directional Line-Switched Ring (BLSR).

In path-switch ring traffic protection is path based. A “path” is a SONET/SDH term for a transport traffic connection all the way between two path-terminating equipment (PTE) nodes. In the event of a failure the entire path is moved (i.e. switched) over a to a protection path.

In line-switched ring traffic protection is line based. A “line” is a term for a SONET line or SDH multiplex section for a transport traffic connection between each pair of line-terminating equipment (LTE) nodes. In the event of a line failure, only that part of the traffic route is changed when the traffic is moved (i.e. switched) over to a protection line at the fault's boundary between the pair of LTEs.

A “mesh network” is defined herein as a group of entities comprised of three or more uni- or bi-directionally connected nodes, with fiber spans between any two nodes, with nodes that are “n-connected” where unlike rings n can be more than 2 (i.e. 3-connected), with single or multiple wavelengths, with working and protection capacity in the mesh or between two or more nodes, and with high physical connectivity.

A “constrained mesh network” is defined herein as a mesh network that has had its architecture constrained by practical factors such as geography, hierarchies, commercial restrictions etc. that limit its physical and logical mesh connectivity. A hub and spoke network is a variant of a constrained meshed, whereby all the n-connected nodes are constrained to being co-located at one or two main sites.

The conventional optical network architecture is designed with little dependence on, or awareness of, the connections between multiple rings or meshes, for connectivity or protection.

The conventional optical network architecture is multi-layer (i.e. optical transport and electrical multiplexing and switching) and multi-protocol (i.e. TDM and IP).

The conventional optical network traffic is deterministic versus best effort (i.e. Internet Protocol networks).

The conventional optical node architecture is designed with electronic based traffic management and control units for managing traffic granularity.

As network traffic increases, service and cost considerations, along with technology advances, are driving the conventional telecommunications networks to de-layer to fewer layers (in order to become more scaleable), namely to an optical physical layer and an electrical service (i.e. packet) layer. This requires the optical physical layer to become more optically granular and service transparent, while still maintaining traffic determinism if transport carriers are to remain competitive and flexible as this de-layering proceeds, and to keep being a robust (i.e. 99.999% availability which corresponds to less than 5 minutes of down time per year) and scaleable transport provider for the underpinning service layer. The optical granularity increases flexibility and maximizes bandwidth efficiency to keep the carrier's optical bandwidth cost competitive so that the carrier can keep providing traffic transport and traffic restoration for the layer above.

### SUMMARY OF THE INVENTION

The present invention endeavors to provide an improvement over existing optical communication systems of the optical transport of granular capacity of bandwidths less than the line rate capacity of the optical transport on a given optical frequency, sometimes referred to as the sub-wavelength or sub-lambda level, with full optical connection oriented bandwidth management, including but not limited to, connection establishment, re-arrangement, protection, route diversity, restoration, aggregation, separation, switching and multi-cast, of that granular capacity, which alleviates totally or in part the drawbacks of prior art, such as SONET/SDH based networks.

According to the present invention there is a provided an optical communications network employing wavelength division multiplexing with wavelength hopping and TDM bursts, comprising a plurality of nodes; aggregation nodes and switch nodes; a transmission medium interconnecting said nodes, said transmission medium being capable of carrying a plurality of wavelengths that are capable of being shared with other optical communications networks; and an interface at each node for dropping a wavelength hopping optical TDM burst for a controlled interval therewith, adding a wavelength hopping optical TDM burst for a controlled interval destined for another node, and passively or actively, the latter for signal conditioning purposes, forwarding wavelength hopping optical TDM burst for a defined interval destined for other nodes; and whereby an interface at each switch node for cross-connecting or switching or overlaying wavelength hopping optical TDM burst between a plurality of transmission medium; and whereby communication can be established directly between a pair of nodes employing wavelength hopping optical TDM burst without the active intervention of any intermediate or intervening node.; and a mechanism for maintaining optical power balance and optical signal integrity in the network when the wavelength hopping optical TDM bursts are intermittent.

It is an aspect of the invention to provide aggregation nodes with interface devices for use in an optical network employing wavelength hopping optical TDM bursted waveslots, comprising a wavelength fixed, semi-agile or fully agile de-multiplexer for dropping waveslots from the network at a node, means for converting the optical signal from said de-multiplexer to signals for generating optical or electrical output signals to subtending “client” devices, and a wavelength agile multiplexer for adding waveslots from the subtending client device optical or electrical input signal to the network.; the said de-multiplexer and multiplexer being arranged so as to have access if desired to all the optical signals. The latter in one embodiment permits inclusion of a waveslot wavelength to wavelength conversion and/or translation device for waveslot cross-connection or waveslot interchange in time, analogous to time-slot interchange (TST). For example, if a connection path is established between node A and node B, over a fiber, and between node B and E over another fiber, but no path fiber path exists between node A and node E, node A can send traffic for node E first to node B, which drops the traffic in the form of waveslots, detects and confirms the waveslots for node E, converts or translates or interchanges the waveslots through an appropriate device and forwards the traffic onto the fiber to node E.

A network in accordance to the invention is protocol and bit rate transparent where the waveslot format is indifferent to the underlying protocol, and is therefore more compatible and forward evolvable with the DWDM metro transport networks that are protocol and bit rate independent (patent CA 02245403). Each traffic payload is carried on separate protocol and bit rate transparent wavelength hopping optical TDM bursts that can be aggregated, separated or rearranged amongst a plurality of optical transmission medium using optical burst wavelength division multiplexing techniques.

An aspect of the invention is that cascaded rings can be supported with inter-connecting nodes as per patent CA 02245403, but since the network can be synchronized to an external synchronization source, such as to a carrier's building integrated timing supply (BITS), non-linear effects such as chromatic dispersion accumulation, and spatial effects like jitter accumulation, can be mitigated without the regeneration complexity as stated in patent CA 02245403.

An aspect of the invention is that optical gain blocks such as fiber amplifiers, such a erbium doped fiber amplifiers (EDFAs), or specialized short fiber amplifiers, or silicon optical amplifiers (SOAs), and linear optical amplifiers (LOAs) are supported for adding amplification to individual wavelengths or groups of wavelengths to achieve the required optical system bit error rate performance.

According to the invention a waveslot is associated with the connection between two or more nodes without the need for the nodes to be on the same pre-assigned “band” of wavelengths as per patent CA 02245403.

In another aspect, the present invention provides a line of sight connection function, with signaling, protection and restoration functions, for the transport of granular optical capacity of bandwidths less than the line rate capacity of the optical transport, referred to hereinafter as a Line of Sight Connection Protocol (LOSP). The LOSP for use with the described signaling format and switching method to enable connection oriented bandwidth management at the granular level, such as the sub-wavelength level, in a network optimized approach, to provide an additional increase in network bandwidth efficiency and flexibility.

According to this aspect of the present invention, the end-nodes of a connection to be established perform the connection establishment and /or re-arrangement process using the LOSP.

According to a preferred aspect the invention, the end-nodes of a connection establish the protection for the connection (whether by dedicated redundancy using a previously unassigned connection or spare link, shared redundancy using a lower priority connection, optical route diversity, or inter-layer route diversity) using the said LOSP.

The end-nodes of a failed shared protected connection to be restored perform the preemption process on lower priority connections to restore on-demand the higher priority shared protected connection using the LOSP. The preempted path may be pre-configured or may be determined at the time of the fault event. The LOSP can perform the restoration in the optical layer or in co-ordination with a higher network layer (such as the Internet Protocol (IP) layer ⅔ levels) in the routers for example.

To be reestablished; the end-nodes of a suspended lower priority connection, suspended say for the purposes of immediate restoration of a shared protected connection, perform the connection restoration process using the LOSP.

The present invention also provides a shareable network-wide, optimized, granular connection capacity, based on information stored and provided by each node, that is coordinated at the network level utilizing LOSP to provide all the above described functions optimized at the optical network level, including any required inter-layer coordination for connection management, aggregation, pre-emption, route diversity.

An advantage of the present invention is improved optical bandwidth efficiency. The invention provides a flexible method for granular bandwidth management, in a wide variety of optical network topologies, including, but not limited to, point-to-point, linear add-drop, collector daisy chain, ring and mesh, with a plurality of connection, protection and restoration options.

### BRIEF DESCRIPTION OF THE DRAWINGS

The preferred embodiments of the invention will now be described in conjunction with the annexed drawings, in which:

FIG. 1 shows a schematic of a reference transport network illustrating the physical layout of a typical transport telecommunication network within which the present invention is applied;

FIG. 2 shows a block diagram schematic of a granular optical burst network showing the physical layout of an optical burst, a multiplexed and switched network according to the present invention;

FIG. 3 illustrates operation of an optical burst network in an example of a mesh connection pattern on an optical burst network as shown in FIG. 1 with examples of payload signals in the waveslot connections, according to the present invention;

FIG. 4 illustrates the optical burst data format in accordance with the invention;

FIG. 5 illustrates the sequencing of the cycles optical burst waveslot of the data format shown in FIG. 4;

FIG. 6 illustrates agile bandwidth mapping into waveslots by optical burst switching of the waveslots from one to two individual transmission mediums with a 3-connected granular optical switch, in accordance with the invention;

FIG. 7 illustrates the agile mapping of the bandwidth into wavelength timeslots, referred to as “waveslots” herein, for a typical system in accordance with the invention;

FIG. 8 illustrates bandwidth aggregation of waveslots, in this case from four transmission mediums to one;

FIG. 9 illustrates how SONET/SDH rates (OC-3/STM-1, OC-12/STM-4 and OC-192/STM64) are granularized with the waveslot format;

FIG. 10 illustrates the compatibility of the waveslot photonic layer format of FIG. 5 for carrying a variety of data of various protocol and bit rate payloads;

FIG. 11 is a system block diagram of a network granular aggregation node with optical burst multiplexing and optional switching capability;

FIG. 12 is a functional block diagram of an example implementation of the two or four fibre network node of FIG. 11;

FIG. 13 is a functional block diagram of an example implementation of the four fibre network node of FIG. 11;

FIG. 14 is a system diagram of a network granular switching node, in this case eight-connected, with optical burst switching capability;

FIG. 15 is a more detailed system diagram of a network granular switch node, with a folded plane and optical burst switching capability;

FIG. 16 is a yet more detailed rendition of the system diagram of FIG. 15;

FIG. 17 illustrates the main options for granular aggregation node to switch node connection via line facility;

FIG. 18 illustrates granular aggregation node to switch node connection via direct connection to the switch fabric;

FIG. 19 illustrates the main option for aggregation node to aggregation node connection;

FIG. 20 illustrates a less service-disruptive and lower pass-through loss interconnection option for expandable aggregation node to aggregation node connection;

FIG. 21 is a functional block diagram of an example implementation of waveslot alignment;

FIG. 22 illustrates an example of a LOSP operation;

FIG. 23 illustrates an example of a LOSP operation to request the establishment (setup) of a connection path or route;

FIG. 24 illustrates the functional format of a LOSP connection seeking control packet (CSP) or message;

FIG. 25 illustrates an example of a LOSP operation to identify open channels for an optimal connection path or route;

FIG. 26 illustrates an example of a LOSP operation for reserving a connection path or route;

FIG. 27 illustrates the functional format of a LOSP connection reservation request control packet or message; and

FIG. 28 illustrates an example of a LOSP operation when the desired connection route is blocked.

### DETAILED DESCRIPTION OF THE PREFERRED EMBODIMENT

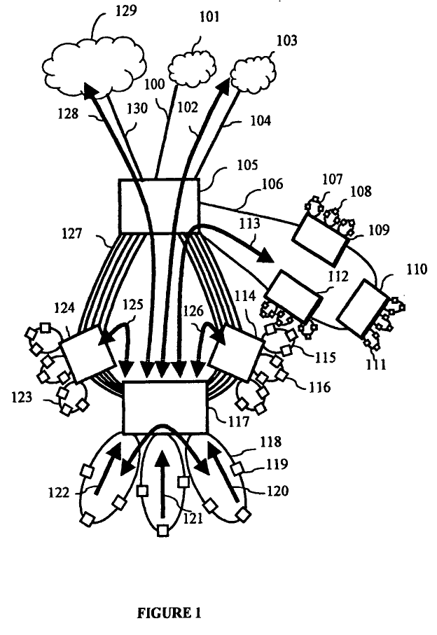

Referring to FIG. 1, it shows a typical telecommunications network consisting of access networks that connect end-users, also referred to herein as clients, to the network and transport networks that provide the interconnection between the access networks. The transport networks can be further separated into a Metro, Regional Inter-Office Facilities (IOF), also referred to as Metro Core, and a backbone or core portions. In FIG. 1, blocks 109,110,112 are metro hub sites of the metro portion of the transport network blocks 114, 117,124 are regional hub sites of the regional portion of the transport network and block 105 the backbone portion of the transport network. Thus, FIG. 1 shows the physical layout of the network. The access networks are under pressure to increase the variety of supported protocols to support emerging services, which typically require higher bit-rates, such as private-line Ethernet(™). The transport networks in-turn, are under pressure to provide more capacity to support the increase in capacity coming from the access networks.

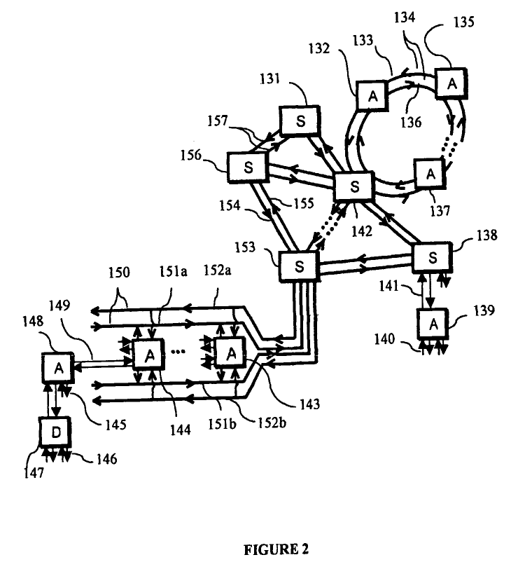

FIG. 2 shows an embodiment of the present invention wherein a plurality of aggregation nodes 132,135,137,139,143,144 and 148 are provided for aggregating and separating the optical data traffic and switch nodes 131, 138, 142, 153 and 156 for cross-connecting the optical data traffic, interconnected in an arbitrary network topology, including rings (as in nodes 132,134,135,137,142), meshes (as in nodes 131,142,138,153,156) and linear chains (as in nodes 143 and 144), by optical transmission media 134,157,150 capable of carrying a plurality of wavelengths. It will be understood that FIG. 2 shows the physical layout of the network. The interconnectivity between the nodes is provided by the wavelength hopping optical bursted waveslots. A device, either wavelength fixed or agile is provided at each aggregation node 132,135,137,139,143,144,148 for dropping and adding the associated wavelengths for a given time interval, wavelength hopping optical bursted data unit (ODU), as fixed length frames in time slots, called waveslots herein, within a repeat interval, and passively forwards other waveslots designated for successive nodes over the transmission medium.

For the ring, on medium 134 each node 132, 135, 137, 142 can add/drop waveslots specific to that node. In order to establish a connection say between node 132 and 137, node 132 transmits in both directions for a 1+1 or 1:1 protected connection, on the counter rotating rings of 133 and 136 waveslots for node 137. 133 and 136 provide two diverse routes on the ring. In the event of a failure of one ring arc, say 136, the other ring arc, in this case 137 provides a restoration path for all the waveslots from the now failed arc 136. The waveslot on ring arc 136 passes through node 135 where it is either passively reflected or actively passed or conditioned and forwarded to node 137 that drops the waveslot and extracts the traffic in the waveslot payload. The waveslot on ring arc 133 passes through switch node 142 where it is either passively reflected or actively passed or conditioned and forwarded to node 137 that drops the waveslot and extracts the traffic in the waveslot payload. In accordance to the principles of the invention, the waveslots that permit the direct, protocol transparent and independent connections to be made between any nodes on the ring without the intervention of any intermediate node. The nodes on the ring can be logically interconnected in various connection manner, for example hubbed, star, meshed etc. by establishing the appropriate connections between the nodes on the ring. If connected in rings, these rings may be connected together such that data traffic can be transmitted and received between adjacent rings.

For the mesh, on media 154 and 155, each switch node 131, 142, 138, 153,156 can rearrange overlapping waveslots between the plurality of optical medium going into (inlet or incoming or ingress or connected from) and out of (outlet or outgoing or egress or connected to) that node. In order to establish a connection say between node 135 and 139, node 135 transmits in both directions, on the counter rotating rings of 133 and 136 waveslots for node 139. The waveslot on 136 passes through node 137 where it is either passively reflected or actively passed or conditioned and forwarded to switch node 142 that per its waveslot connection map, redirects or “switches” the waveslot to a outlet fibre that will carry the waveslot to node 139. In this example, assume that is the fiber to switch node 138. The waveslot goes to switch node 138 where it is redirected to a fiber that in this case connects directly to aggregation node 139, its intended destination. Node 139 drops the waveslot and extracts the traffic in the waveslot payload. The waveslot on 133 passes through node 132 where it is either passively reflected or actively passed or conditioned and forwarded to switch node 142 that per its waveslot connection map, redirects or “switches” the waveslot to a outlet fibre that will carry the waveslot to node 139. In this example, assume that is the fiber to switch node 156. The waveslot goes to switch node 156 where it is redirected to a fiber to switch node 153, which redirects it to a fiber to switch node 138 that in this case connects directly to aggregation node 139, its intended destination. Node 139 drops the waveslot and extracts the traffic in the waveslot payload. In accordance to the principles of the invention, the waveslots that permit the direct, protocol transparent and independent connections to be made between any nodes on the mesh using a format that permits granular all-optical switching of the waveslot at the switch node from a plurality of incoming fibers to a plurality of outgoing fibers. The nodes on and connected to the mesh can be logically interconnected in various connection manners, for example hubbed, star, meshed etc. by establishing the appropriate connections between the nodes on the mesh.

For the linear add-drop chain, a variant of an optical tree, on physically diversely routed medium 151a, 152a and 151b, 152b, each node 143, 144, 153 can add drop waveslots specific to that node. In order to establish a connection say between node 143 and 148, node 143 transmits on 152a, and if the connection is 1+1 or 1:1 protected on 152b for node 148. The waveslot on 152a passes to node 144 where it is dropped for forwarding to node 148, over 149 that drops the waveslot and extracts the traffic in the waveslot payload. Likewise the waveslot on 152b passes to node 144 where it is dropped for forwarding, over 149, to node 148 that drops the waveslot and extracts the traffic in the waveslot payload.

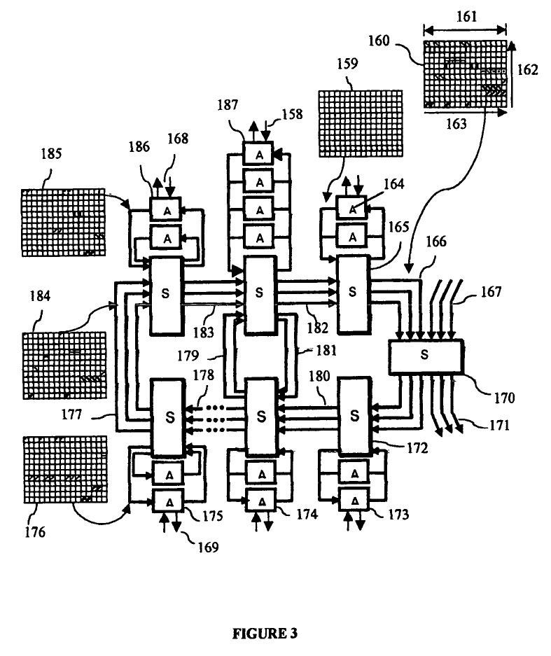

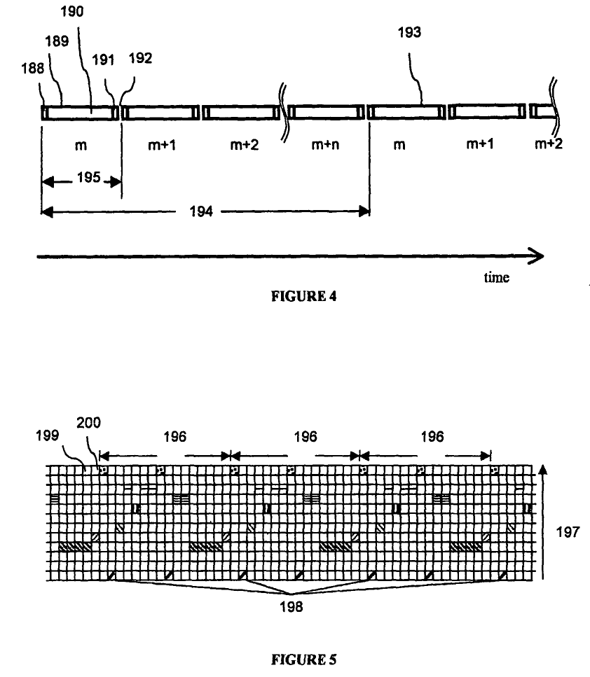

Referring now to FIGS. 3 and 4, it is the waveslot format that allows the network to be protocol independent. A device, either wavelength fixed or agile is provided at each aggregation node A of the aggregation node chains 186,187,164,175,174 and 173 for adding waveslots from the node to the transmission medium connected to the switch nodes S at the head of each chain. Communication betweens nodes, such as between 186 and 173 for the purposes of management and control can be established directly with a dedicated management waveslot or indirectly by appending the information to a traffic carrying waveslot between the pair of nodes 186 and 173 without the active intervention of intermediate nodes.

The device, either wavelength fixed or agile, provided at each aggregation node A of the aggregation node chains 186,187,164,175,174 and 173 for dropping and adding the waveslot can be programmed so that the dropped and added waveslots are at different wavelengths for a connection. This permits lower optical isolation variants of components, such as optical filters, to be used for cost sensitive applications.

Each transmitter can provide a single colour at any given time, so the link state-matrix is 'singly filled. The optical switch nodes are able to route the waveslots through the nodes, and so overlay the link state matrices 159,176,184 to make multiply filled matrices, such as 160, with each waveslot entering the switch from an input (inlet or ingress or connected from) fibre following the required path through the node and onto the appropriate output (outlet or egress or connected to) fibre.

A connection from a transmitter to a receiver is formed as an optical signal, which is transmitted in the correct waveslot (correct timeslot and at the desired wavelength) to traverse the switch node where it can be switched from the inlet or ingress optical fibre to the egress or outlet optical fibre as it moves from switch node to switch node in the network. The path through the network the data signal traverses is controlled in this manner by the optical switches through which it propagates until it reaches its destination. The choice of waveslot (wavelength and timeslot) for transmission is determined by the network connection setup system and connection setup protocol.

FIG. 3 shows a mesh connected network, ring structure shown for clarity. The switch nodes S are photonic cross-connects that space switch like-waveslots per wavelength plane. Switch node 170 manages tandem traffic without optical add/drop. Aggregation node 164 is providing OC-192 pass-through on the second wavelength as indicated in pattern 159. Node 186 is transporting GbE traffic as indicated in pattern 185.

The waveslot 189 in FIG. 4 is the fundamental unit of bandwidth for the invention. The waveslot is connection oriented. The waveslot is used to transport data traffic in fixed or variable intervals in duration on wavelengths on the transmission medium between nodes, which may be non-adjacent. The same waveslot in each cycle has the same wavelength to simplify connection management. Higher bandwidths than the capacity of a waveslot per connection channel are achieved by using multiple contiguous or non-contiguous connections. Having the waveslots contiguous simplifies alignment for switching. The waveslots are transmitted in a repeating cycle, with typically a fixed duration on each wavelength The cycle time is chosen based on update rate and desired latency through the network. The waveslot duration is chosen for optimum bandwidth granularity−minimum managed bandwidth=(line rate)/(number of waveslots per cycle).

For example, sixty-four forty-microsecond waveslots will fit within a 2.56 ms repeat interval. If the nominal line rate is ˜10 Gb/s, then each waveslot within the repeat interval equates to a connection of ˜150 Mb/s

The format of the waveslot is optical transport Network (OTN) compatible. Current ITU-T OTN defines multiple channels per wavelength, with nominally one channel per wavelength. The channels supporting path rates of 2.5 Gbps, 10 Gbps, or 40 Gbps. The channels have a common digital frame structure, with defined payload and overhead information area. The invention supplements the OTN compatible format with the concept of a sub-wavelength channel that has a repeating OTU frame compatible size. 425 OTN waveslots per second provides a nominal 50 Mbps Sub-wavelength channel. Therefore a 10 Gbps wavelength will have 192 sub-wavelength channels that can be transported in 192 waveslots per cycle 194 in FIG. 4.

The connection capacity of a switch equals total number of channels equals S×F×C, where s=number of waveslots, F=number of fibers, and C=number of colours (wavelengths or lambdas). For S=16@OC-12, C=40, F=6 the total number of OC12 channels equals 3,840. Where S=64 @OC-3, C=40, F=6 the total number of OC-3 channels equals 15360.

The waveslot format shown in FIG. 4 is referred to herein also as the Photonic burst Switch Transport format (PSTF). Waveslot 189 consists of the preamble 188 of bits that serves as a label or tag to identify the source of the waveslot and contains information that a receiver can use to verify there is no collision with another waveslot or wavelength from another transmitter, the payload 190 that carries the data traffic, and assists in clock recovery and the tail label or tag, 191, that contains error detection and connection management information. Aside from the clock recovery assist information the rest of the information in the head and tail tags does not have to be ahead of the data payload 190, and could even be superimposed on the payload, say by using a sub-carrier or a similar technique.

A connection is a waveslot, channel rate (i.e. the service rate, like OC-12/STM-4 where 4 concatenated waveslots are required per connections colour (i.e. wavelength), and fibre combination available through the system from source to destination. The connection is typically bi-directional and symmetrical, but can be unidirectional, asymmetrical, diverse paths for each direction etc.

The transmitter at the node, whether fixed or agile provides the dynamic wavelength allocation, called wavelength hopping herein, for each waveslot. For maximum system flexibility the transmitter and receiver at the node has access to all the operational system wavelengths.

The information contained in 191 and 188 is employed by the connection management system to detect erroneous connection states such as misconnection, multiple connections, multiple transmitters (senders) and multiple receivers (listeners).

The duration 195 of a waveslot is flexible, but will be typically fixed for the network. Larger transport bandwidths can be achieved through the use of multiple contiguous or non-contiguous waveslots or wavelength 192, the blank or undefined interval, delineate and is also a guard or transition band for a waveslot The blank, or undefined interval may be populated with fill bits, training bits, marshalling bits or the like to speedup the burst receiver's acquisition times. Each waveslot in a cycle 194 may have a different wavelength.

The same waveslot, for example 193, in each cycle has the same wavelength. Waveslots are routed as connections. Optical switches capable of switching at the waveslot level overlay cycle 194. Optical switch transition occurs during the blank/undefined time 192. Adjustment of optical fiber to fiber timing alignment occurs during the blank/undefined time 192. The management system ensures there are no data collisions amongst waveslots on the transmission medium.

FIG. 5 shows the wavelength hopping pattern for a single agile transmitter, in what is referred herein as a photonic link state matrix, corresponding to an optical burst switching system with 12 wavelengths on the transmission medium. The waveslots are represented as squares on the pattern. Time is the vertical columns, and wavelength, 197, the horizontal rows, with one row per wavelength In this case 12 rows for 12 wavelengths. An empty square, like 199, indicates an absence of a waveslot, i.e. idle or no-connect, for that wavelength and time, during that cycle 196. A filled square, like 200, indicates the presence of a waveslot, i.e. busy, for that wavelength and time, during that cycle 196. The minimum rate connection rate is one waveslot per cycle, as shown by 198, that repeats every cycle 196.

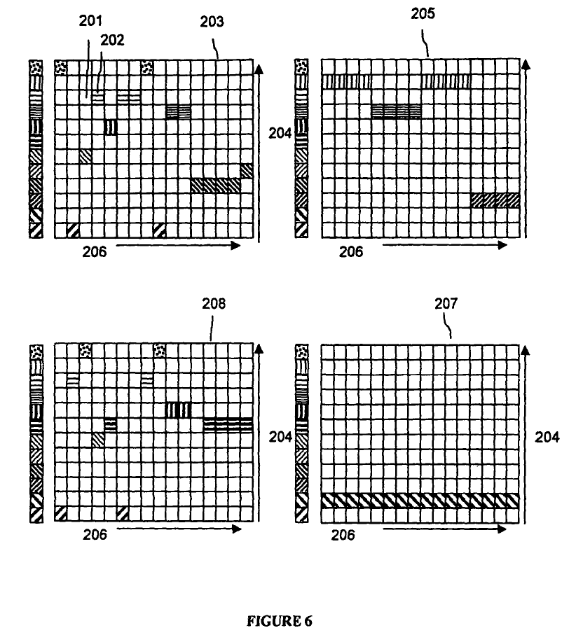

FIG. 6 shows wavelength agile bandwidth mappings for four separate single agile transmitters. The photonic link state matrix has wavelength as the rows, 204. In this example 12 wavelengths counting from the bottom to top, and time, 206 as the columns. A single transmitter transmits a single wavelength in a single waveslot, with the transmission wavelength varying from waveslot to waveslot, i.e. 201 to 202, within the set of discrete wavelength colours used in the particular network. Typically the network may carry, for example, 20 or 40 wavelengths that are hopped across for providing waveslot interconnectivity between nodes. The wavelengths can be different spacing frequencies, for example, 200 GHz or 1.6 nm spacing, 100 GHz or 0.8 nm spacing, 50 GHz or 0.4 nm. spacing etc.

In FIG. 6, 203 is for transmitter number one transmitting mixed services over waveslots. 205 is for transmitter number two transmitting OC-48 based services over waveslots. 208 is for transmitter number three transmitting mixed services over waveslots. 207 is for transmitter number four for transmitting OC192 services over waveslots in the second wavelength of the 12 wavelengths.

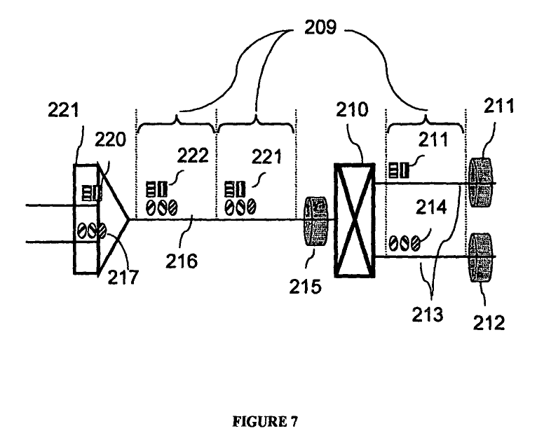

In FIG. 7 the optical switch is used for fibre-to-fibre routing of waveslots through the network. Each fibre supports multiple wavelengths and each wavelength supports multiple waveslots. Shown are the three dimensions to the bandwidth aggregation and separation and management. The transmitter color domain, that does the lambda hopping, aggregation node or time multiplexer that works in the time domain, i.e. different waveslot bursts, and the optical switch that works in the space domain, i.e. different fibres. The management system provides the connection establishment i.e. setup and connection release i.e. tear down.

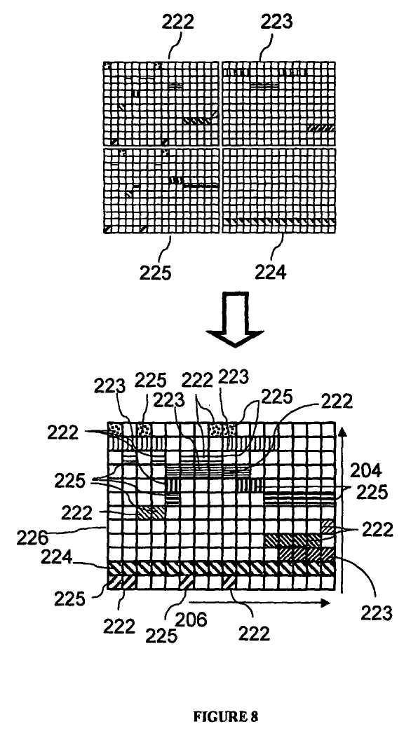

FIG. 8 shows how waveslots from four separate transmitters are aggregated using PSTF. The singly filled link state matrixes 222,223,224, and 225 can be aggregated into one combined, multiply filled link state matrix 226 as shown, at the aggregation node or the switch node. The management system utilizes the LOSP protocol to enable this aggregation by ensuring that when signals from multiple transmitters are to be multiplexed onto one transmission medium, the colours of the wavelengths selected per waveslot at a given time by each transmitter are not overlapping with other transmitters.

FIG. 9 shows the granularity maps for three transport capacities demonstrating the improvement in granularity with increasing waveslots per wavelength. 206 is time, 227 is wavelength, in this case 1 to 80. 230 is 80 channels, 1 waveslot per wavelength, of OC-192/STM-64 or 10 GBE, of wavelength managed services. 229 is 1280 channels, 16 waveslots per wavelength, of OC-12/STM-4 rate or GBE/2 (i.e. 640 GbE) level managed services, and 228 is 5120 channels, 64 waveslots per wavelength, of OC-3/STM-1 or GbE/8 (i.e. 640 GbE) level managed services.

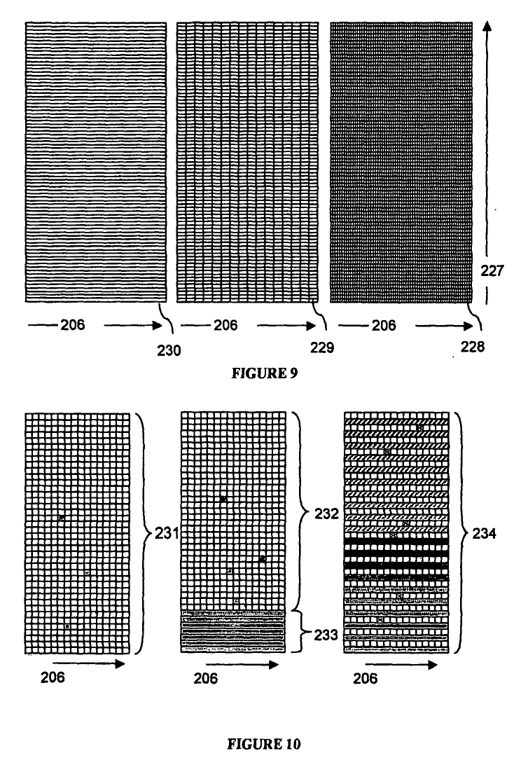

FIG. 10 shows how the system could be run in parallel or even overlayed with other existing and future wavelength systems in an optical network. 231 is a link state matrix for an 80 wavelength optical burst network employing waveslots only for full granular managed bandwidth services. The network could be shared with other optical networks by allocating a contiguous block of wavelengths 233 to the other network for conventional wavelength services and leaving the rest 232 for the optical burst network for granular managed bandwidth services. The network could be shared with other optical networks by interleaving wavelengths 234 between the networks for service separation.

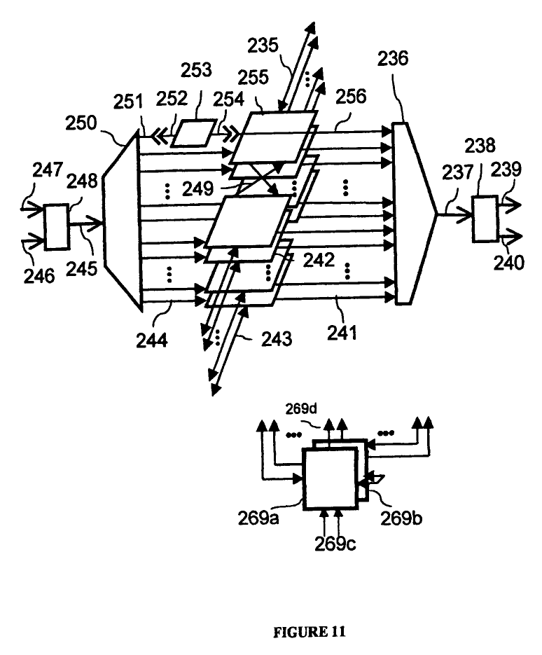

A typical aggregation node is shown in FIG. 11. 247 and 246 are the incoming fiber (inlet or ingress or connected from) and 239 and 240 the outgoing (outlet or egress or connected to) that are connected to the linear chain, ring or mesh network 248 and 238 are optical fiber switches for traditional trunk protection switching, where one fiber is selected as “working”, say 247 for unit 248, and 239 for unit 238, and the other fiber is designated for “protection”, in this case 246 for unit 248, and 240 for unit 238. In the event of a failure the optical switch under the node management system supervision switches the physical connection from the working to the protection. 238 and 248 can operate independently of each other. The trunk protection switch units 248 and 238 are optional, and if not equipped, only a single incoming fiber connects directly to 245 and a single outgoing fiber connects to 237. A demultiplexer (DEMUX) 250 connects to 248 and a multiplexer (MUX) 236 connects to 237. Demultiplexer 250 drops or forwards waveslots or wavelengths to the interface units 242,255 and multiplexer 236 adds or forwards waveslots or wavelengths from the interface units 242, 255.

Physically DEMUX 250 consists of either an agile optical filter or a fixed optical filter followed by an optical switch. The filters transmit the waveslot at the desired wavelength to be dropped to the interface units 242 and 255 over connections 244, and pass the remaining waveslots over connection 251.The agile filter can be, for example a tunable Lithium Niobate (LiNbO3) based periodic poled filter, or a tunable Fabry-Perot filter. A suitable filter is in the process of being made by Dense Optics inc. of Quebec, Canada. The fixed filter can be, for example, interference filter, array Waveguide, fiber Bragg Grating, Dispersive filter etc. A suitable fixed filter is made by JDSU of Ottawa Canada. Both types of filters have suitable isolation, add/drop loss and pass-through insertion loss. The DEMUX unit can also be based on coarse filters; in that case multiple wavelengths and thus waveslots will be dropped referred to as gang-dropped or group dropped, herein. Optical switch can be a LiNbO3 based switch or a Silicon Optical Amplifier (SOA) based optical switch. A suitable switch is in the process of being offered by Trellis, LightCross, Corning, and JDSU etc and is representative of other vendor's switches.

Physically MUX 236 consists of either an agile optical filter or an optical switch followed by a fixed optical filter or a broadband optical combiner. The filters transmit the waveslot at the desired wavelength to be added from the interface units 242 and 255 over connections 241, and passed with the remaining waveslots from 250, via 251, 252, through an optional optical signal conditioning (and/or amplification and/or wavelength translation and/or wavelength conversion) unit 253 through 254 and over connection 256. The agile filter can be, for example a tunable LiNbO3 based periodic poled filter, or a tunable Fabry Perot filter. A suitable filter is in the process of being made by Dense Optics inc. of Quebec, Canada. The fixed filter can be, for example, interference filter, array Waveguide, fiber Bragg Grating, Dispersive filter etc. A suitable fixed filter is made by JDSU of Ottawa Canada. Both types of filters have suitable isolation, add/drop loss and pass-through insertion loss. The MUX unit can also be based on a coarse filter, in that case multiple wavelengths and thus waveslots will be added referred to as gang-dropped or group added, herein. Optical switch can be a LiNbO3 based switch or a Silicon Optical Amplifier (SOA) based optical switch A suitable switch is in the process of being made by Trellis and by LightCross, and is representative of other vendors. The MUX can also be based on a broadband optical combiner. A suitable combiner is made by JDSU of Ottawa Canada.

The DEMUX can be equipped with waveslot and wavelength monitoring circuitry to monitor optical signal performance and integrity such as optical power levels, wavelength accuracy, optical power stability, optical signal noise ratio etc. for both a quality measure and for triggering protection switching, on consistent or intermittent degradations or faults, or waveslot connection re-routing from degraded paths. The monitoring information can also be used by the optional signal conditioning unit 253 to optimize its operation, using locally and/or globally driven optimization algorithms.

The dropped waveslot from the DEMUX 250 is passed to the appropriate interface units 242 and 255.

The interface unit 242 and 255 optical receive side connected to 244 from the DEMUX 250 consists of an optical detector, burst receiver, ancillary receive electronics to route the signal to the client transmit circuitry connected to 243 for 242 and 235 for 255.

The interface unit 242 and 255 optical transmit side connected to 241 to the MUX 236 consists of ancillary transmit electronics to take the signal from the client receive circuitry connected to 243 for 242 and 235 for 255, and pass it to mapping circuitry to format the signal into waveslots for forwarding to a wavelength agile optical transmitter, such as a tunable laser module, that transmits the waveslot to the MUX 236 over 241. The laser module ancillary circuitry with specialized electronics controls the wavelength control, laser current, modulation current, operating temperature if a thermal electric cooler is utilized for the desired wavelength, average optical power, peak power, noise interference compensation, extinction ratio, optical power broadband modulation etc for the waveslot or wavelength.

Protection links 249 exist for supporting equipment protection between 242 and 255 interface units in 1+1, 1:1, 1:N etc.

The adding of waveslots works in the same way as dropping waveslots but in reverse. The nodal management system 269a and redundant units 269b for the aggregation node consists of a maintenance unit, a supervisory unit, an external synchronization unit to synchronize to BITS and an optical supervisory channel (OSC) unit. All of which can be 1+1 or 1:1 protected. Each unit will typically contain an embedded processor module with processor, volatile and non-volatile RAM and ROM memory, running a multi-tasking operating system. Typically FLASH memory for program store and application store. The units will typically have a plurality of serial and parallel, electrical and optical interfaces for machine-to-machine and machine-to-person communications. The application store contains application software for control, maintenance, status monitoring, performance monitoring, and network management protocols. Communication protocols, alarming detection and reporting, protection and restoration, communications and control loops for managing the detectors and transmitters etc. The aggregation node may be controlled and monitored by a software running on a remote computer, say using a telnet session over TCP/IP, or by a network operating system.

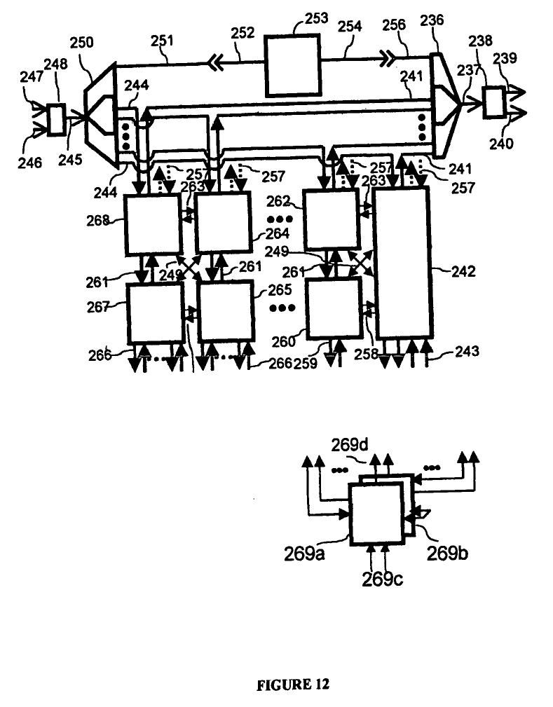

The aggregation node as shown in FIG. 12, is a more detailed representation of the two and four fiber aggregation node in FIG. 11.

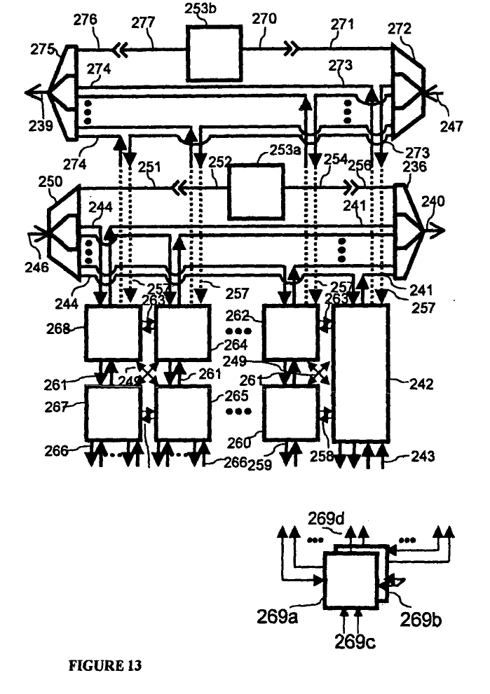

The aggregation node as shown in FIG. 13 is a four fiber connected variant of the node shown in FIG. 12.

In FIG. 13 the aggregation node is equipped for four fibres. One fibre connected to outlet 239 going to the “west” adjacent node, one fibre connected to the inlet 246 coming from the “west” adjacent node, one fiber connected to inlet 247 coming from the “east” adjacent node, and one fiber connected to outlet 240 going to the adjacent “east” node. 275 and 236 are MUX units, 272 and 250 are DEMUX units, 253a, 253b are the conditioning and/or signal conversion and/or wavelength translation units, and/or interchange units. 268,264,262,242 are the facility interface units that waveslots are dropped and added from and to the network, while 267,265,260 are the client interface units that interface to the subtending equipment whose data is being transported. Facility interface units can be 1+1, 1:1 and 1:N protected, using signals links between the units such as 249 and 261. Unit 242 is a specialized unit that is a combined facility unit and client interface unit. Unit 242 has also an integrated trunk switch for protecting the client connections 243.

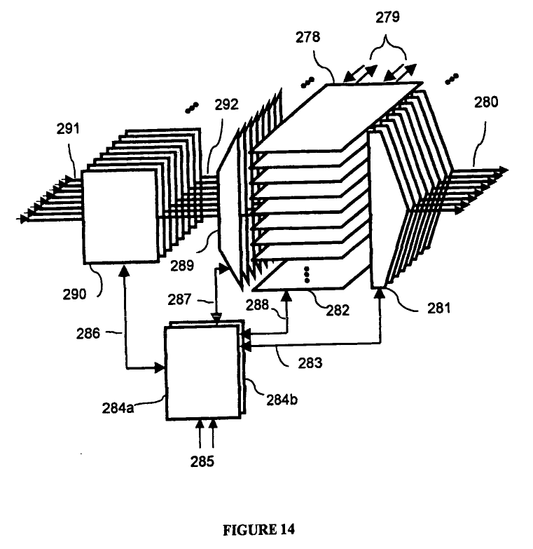

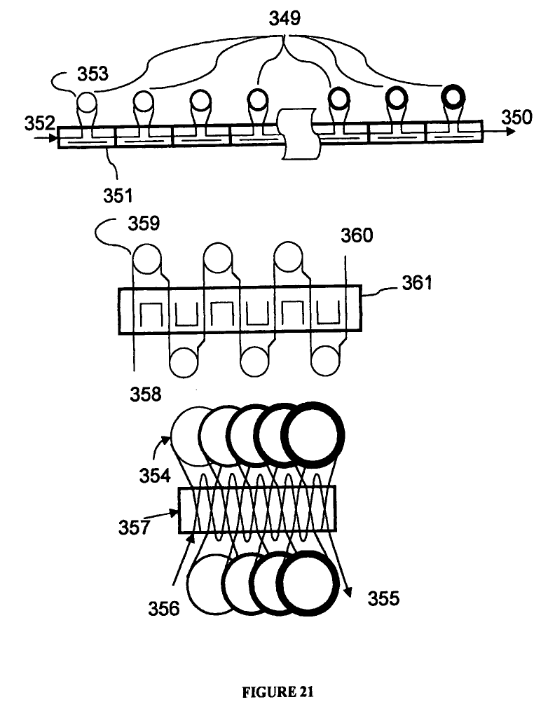

The nodal management system 269a and redundant units 269b is as previously described. The switch node in FIG. 14 is shown as an example. The optical taps for monitoring are not shown for clarity purposes. The inlet fibers 291 connect to 290 the waveslot alignment units, further detailed in FIG. 21, that compensate in the skew of the waveslot cycles in time due to the different fiber lengths being traversed. The appropriate delay is switched in for each fiber under the nodal management system control in relation to the external network BITS clock 285 received at the management units 284a and 284b. The compensated optical signals are forwarded to the de-multiplexer units (DEMUX) 289 over 292.

The DEMUX can be agile or fixed filter, but fixed filter are sufficient, for example, 20 or 40 or 80 channel Array Waveguide (AWG) or fiber Bragg Grating or Dispersive filter etc. A suitable fixed filter is made by JDSU of Ottawa Canada. Any high channel count optical filter that has suitable isolation, little polarization dependence, add/drop loss and pass-through insertion loss can be used in DEMUX. The DEMUX unit can also be coarse, in that case multiple wavelengths and thus waveslots will be dropped referred to as gang-dropped or group dropped, herein. The DEMUX can be equipped with waveslot and wavelength monitoring circuitry to monitor optical signal performance and integrity such as optical power levels, wavelength accuracy, optical power stability, optical signal noise ratio etc. for both a quality measure and for triggering protection switching, on consistent or intermittent degradations or faults, or waveslot connection re-routing from degraded paths. The monitoring information can also be used by the optional signal conditioning unit 253 FIG. 12 and 253a and 253b in FIG. 13, in the aggregation nodes to optimize its operation, or locally in the switch node units, using locally and/or globally driven optimization algorithms.

The dropped waveslots based on wavelength from the DEMUX 289 is passed to the appropriate switch units 278. The switch units can be built around Lithium Niobate (LiNbO3) based switches or a Silicon Optical Amplifier (SOA) based optical switch or any sub-100 ns optical switching device. A suitable switch is in the process of being made by Trellis and by LightCross, and is representative of other vendors. The switches can be as a minimum 4×4, but can be 8×8, 16×16 etc. The switch unit is a plane space switch that switches the waveslot based on a connection map (i.e. look-up table) stored in memory in the nodal management units 284 and 284, to the appropriate multiplexer unit (MUX) 281. The connection map in memory is configured by a call set-up procedure which creates the appropriate mapping of waveslots from ingress space switch ports to egress space switch ports. The lookup table validates that a waveslot corresponding to a given switch-port and fiber has originated from the correct aggregation node port If the connection management system finds that data in a given waveslot has originated unexpectedly from an incorrect aggregation node port, fault correction procedures will be triggered; at the same time the offending waveslot will not be switched through the Photonic cross-connect switch module 278.

The MUX unit 280 can be based on a broadband optical combiner or it can be an agile or fixed filter, but fixed filter are sufficient, for example, 20 or 40 or 80 channel array Waveguide or fiber Bragg Grating or Dispersive filter etc. A suitable fixed filter is made by JDSU of Ottawa Canada. Any high channel count optical filter that has suitable isolation, little polarization dependence, add/drop loss and pass-through insertion loss can be used in DEMUX The MUX unit can also be coarse, in that case multiple wavelengths and thus waveslots will be added referred to as gang-added or group added, herein. The output of the MUX unit 281 connects to the outlet fibers 280. One outlet fiber per MUX unit. The MUX units 281 can be optionally fitted with gain elements such as an SOA or LOA with a programmable attenuator. Suitable components are available from JDSU or Corning or Kamelian. The attenuator is used for optical power equalization amongst waveslots passing through 281, balancing the optical power levels from waveslots that have traverse different fibre distances etc therefore overcoming the problem of waveslot optical gain adjustment. This can be done independently of other nodes in the network or in conjunction with them to achieve the most optimal end-to-end system performance. The attenuators can also be placed in 278 either before or after the optical switch (pre- or post).

The MUX unit 280 also has tunable laser transmitters for performing optical power fill by inserting appropriately place optical signals in the optical spectrum for stabilizing optical amplifiers.

The management units 284a and redundant unit 284b for the switch node consists of a maintenance unit, a supervisory unit, an external synchronization unit to synchronize to BITS 285 and an optical supervisory channel (OSC) unit All of which can be 1+1 or 1:1 protected. Each unit will typically contain an embedded processor module with processor, volatile and non-volatile RAM and ROM memory, running a multi-tasking operating system. Typically FLASH memory for program store and application store. The units will typically have a plurality of serial and parallel, electrical and optical interfaces for machine-to-machine and machine-to-person communications. The unit is equipped with dedicated control electronics for controlling and interfacing to the waveslot alignment units. The unit can be optionally fitted with a shared optical monitor system with optical power, wavelength, OSNR, Q monitor etc capability. The application store contains application software for control, maintenance, status monitoring, performance monitoring, and network management protocols. Communication protocols, alarm detection and reporting, protection and restoration, communications and control loops for management the waveslot alignment, power equalization, optical power fill transmitters etc. The switch node may be controlled and monitored by a software running on a remote computer, say using a telnet session over TCP/IP, or by a network operating system

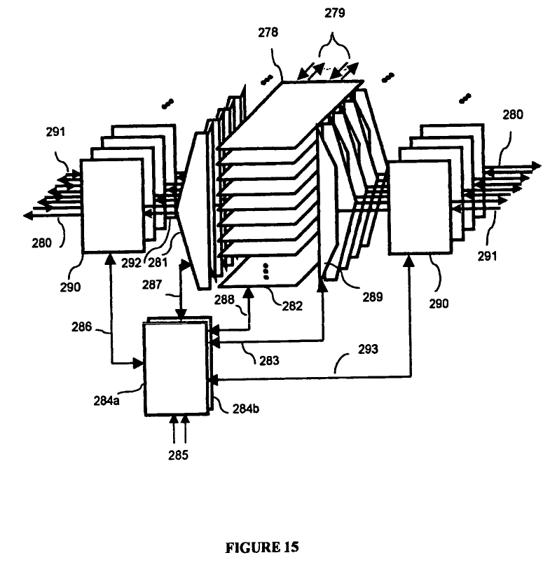

FIG. 15 is similar to FIG. 14 in operation except that the inlet and outlet fibers have been interleaved to fold the plane switch fabric 278 to permit hair-pinning and loop-back of waveslots using a single 4×4 switch.

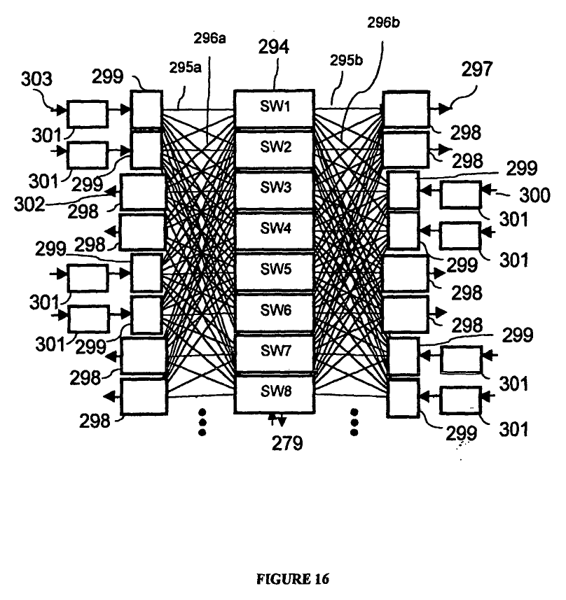

The switch unit 278 of FIG. 15 is shown in more detail in FIG. 16. In this example the eight 8×8 optical space switch modules 294 form a wavelength plane that is fully folded by having both waveslots and/or wavelengths from inlet and outlet fibers interleaved passing through the space switches permitting hair-pinning and loop-back of waveslots on the same switch device. During operation the switch operates in a plurality of states based on combinations of the BAR state, the CROSS state and the ISOLATE state the basic building blocks of the switch. As larger switches become commercially available they can be incorporated in this architecture.

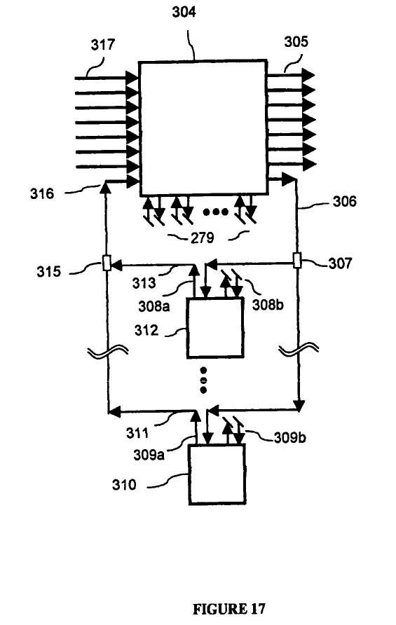

In FIG. 17, illustrates a method for connecting an aggregation node a switch node via the facility (tandem) fibers—facility fibers that typically connect to other switch nodes in a mesh network. In the example aggregation nodes 312, 310 connect to switch node 304 on 316, one of the inlet fibers 317 to the switch node and to one of the outlet fibers 306 of 305 from the switch node. In this example node 310 output add port 311 and node 312 output add port 313 connects to 315 that connects to 316. 315 can be just a splice or a combiner or it can be incorporated into the aggregation node. The switch node outlet fiber 306 connects to 307, which connects to node 312 input drop port 308a and node 310 input drop port 309a. 307 can be just a splice or a combiner or it can be incorporated into the aggregation node. Port 308b on node 312 and port 309b on node 310 can be connected in a similar manner to switch node 304 on another set of inlet and outlet fibers for optical link redundancy, or ports 308b and 309b can be connected to another switch node for matched switch node operation for site redundancy, or ports 308b and 309b may be left unconnected, and used for test access etc.

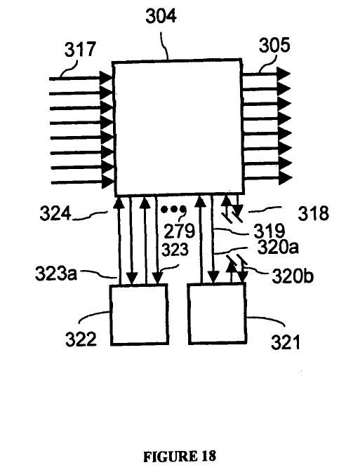

In FIG. 18, illustrates a method for connecting an aggregation node to the switch units, 278 in FIGS. 14 and 15, and 294 in FIG. 16, of a co-located switch node, bypassing the DEMUX and MUX units, therefore avoiding the use of valuable facility (tandem) fibers that instead can be used to connect to other switch nodes or more remote aggregation nodes. In the example aggregation node 322 output and input port 323, both primary 323a and secondary ports 323b for full link redundancy, connect to the switch units of the switch node via links 324 that connect to the links 279 of the switch units. Aggregation node 321 primary output and input port 320a connect to the switch units of the switch node via links 319 that connect to the links 279 of the switch units. The secondary port 320b of node 321 can be connected in a similar manner to switch node 304 to 318 for optical link redundancy, or the secondary ports 320b can be connected to another switch node for matched switch node operation for site redundancy, or secondary ports 320b and switch port 318 may be left unconnected, and used for test access etc.

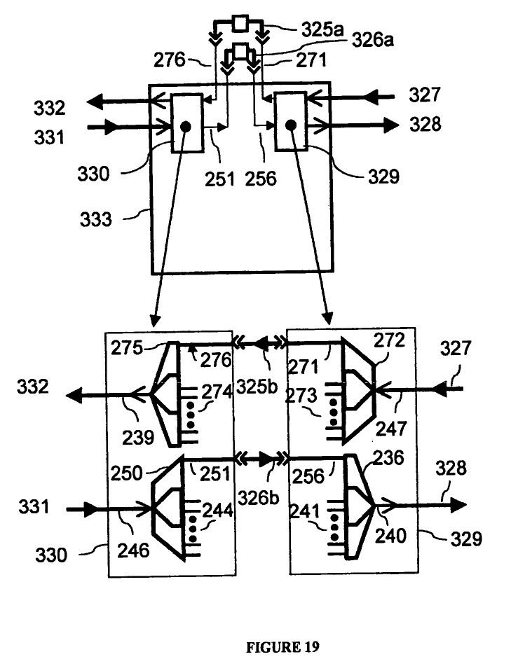

FIG. 19 shows how the DEMUX and MUX units of a 4-fiber aggregation node, (as show in FIG. 13) are typically connected. Pass-through port 271 of DEMUX unit 272 is connected passively with fiber 325b or actively with a compensating unit 325a to inlet pass-through port 276 of MUX unit 275. Pass-through port 251 of DEMUX unit 250 is connected passively with fiber 326b or actively with a compensating unit 326a to inlet pass-through port 256 of MUX unit 236.

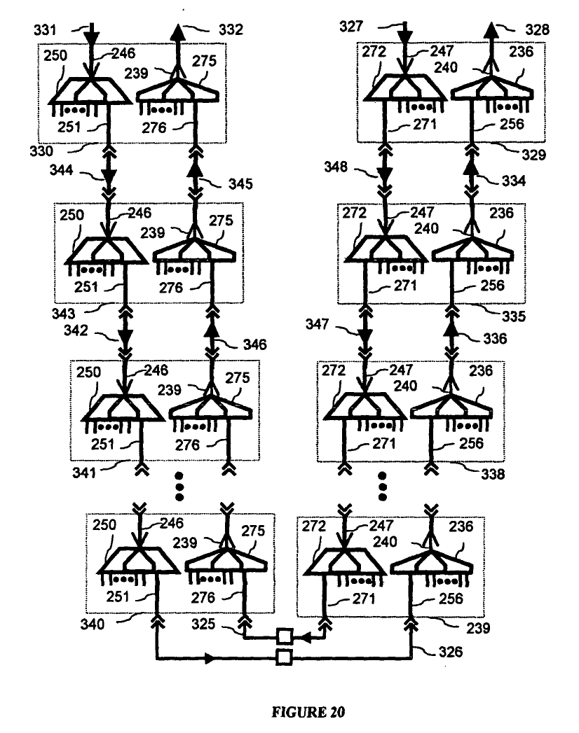

In FIG. 20, shows how the DEMUX and MUX units of a 4-fiber aggregation node that are collocated can be connected to minimize pass-through loss. For the inlet fiber 331 to outlet fiber 328 the WEST DEMUX units 250 are serially connected from the aggregation nodes than the EAST MUX units 236. Likewise for the opposite direction for inlet fiber 337 to outlet fibre 332 the EAST DEMUX units 272 are serially connected from the aggregation nodes than the WEST MUX units 275.

The system management to ensure the phase of the waveslots generated by the transmitter is aligned to the optical switch node timing, when the waveslots arrive at the optical switch controls the precise timing of transmitter output Waveslots arriving from other switch nodes are phased appropriately by propagation through switched fibre delay line systems, which align the waveslots to the switch operation, (units 290 in FIGS. 14 and 15) using the arrangement illustrated in FIG. 21. Until optical delay devices become commercially available a straightforward approach is to form the desired delay using fixed fibre lengths, arranged in an exponential sequence, that are switched in and out to introduce the desire delay for the duration on the fibre span.

Typical packaging for such delay elements is shown in FIG. 21. 351 is an array of 10 fibre based delay elements 349. Each delay element 353 is a loop of fibre. The switches for switching in and out the loops are contained in 351. The target is less than 2 dB insertion loss per element 352 is the input, 350 is the output. An alternate packaging geometry is shown with 361. A more compact packing is shown with 357 where 354 is fibre delay loop, 356 is the input and 355 is the output. The switches are packaged inside 357. The packaging for the alignment unit is similar to that of commercially available fiber based chromatic dispersion compensation modules.

The delay can be both locally optimized, however this approach uses end-to-end optimization. Which is more complete and exact in terms of being able to adjust for variations in network topologies that affect the amount of delay that needs to be introduced. It also permits consideration to be given for reducing the specifications, absolute or relative, or the specification tolerance o other network components and elements that affect delay.

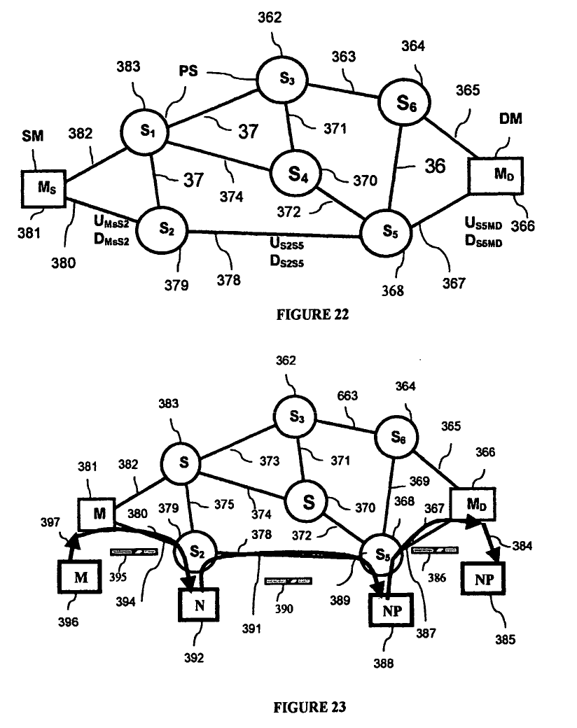

The Line of Sight control (LOSP) Protocol that controls the setup, management and takedown of a connection is shown by a simplified example in FIGS. 22 to 28.

FIG. 22 shows how the LOSP is designed to try the shortest and least congested path first to send data traffic from the source node 381 to the destination node 366. Assigning two specific link metrics to each link does this. The first is a percentage utilization (example: U_{M}_{₅}_{^{S}}_{₂} in FIG. 22) that is updated every 5 or 10 minutes or so from information sent by the switch nodes 383,362,364,370,379 and 368 to all the aggregation nodes in the line of sight. The second is a nominal distance (example: D_{M}_{₅}_{^{S}}_{₂} in FIG. 22), which is provisioned at start up to reflect link cost based on distance between nodes. The original copy of this link state information is kept locally at the switch node. The link state information can be sent to anode in the event of it re-joining the network after restart or upon initial first connection.

FIG. 23 shows an example of a connection request. The end user on the device 396 requests a connection for N×OC-3s from the 396 connected to aggregation node 381 (labeled M_{S}) over fibre 397, to the multiplexer 385, connected to destination aggregation node 366 (labeled M_{D}) over fibre 384. Source node 381 computes Dijkstra to determine shortest nominal path to 366. Dijkstra link cost parameter is a product of basically the percentage of link utilization and nominal distance. The example route 394 to 391 to 387, over fibre 380, 378 and 367 respectively through nodes 379 (S₂) and 368 (S₅) is identified. At this point the protocol does not know if any channels over waveslots are available over this path. The Line of sight protocol finds open channels from source to destination over this path. If an open channel(s) is found, the management process at node 381 sends a connection seeking message/packet 395 to the first switch node 379 on the selected path (route). The message/packet can be sent in-band via a management waveslot to the switch node or out of band via a separate IP control network. The nodal processor at switch node 379 updates the message/packet and sends it 390 on to the next switch node 368, which updates it as well and sends it 386 where it reaches the destination node 366.

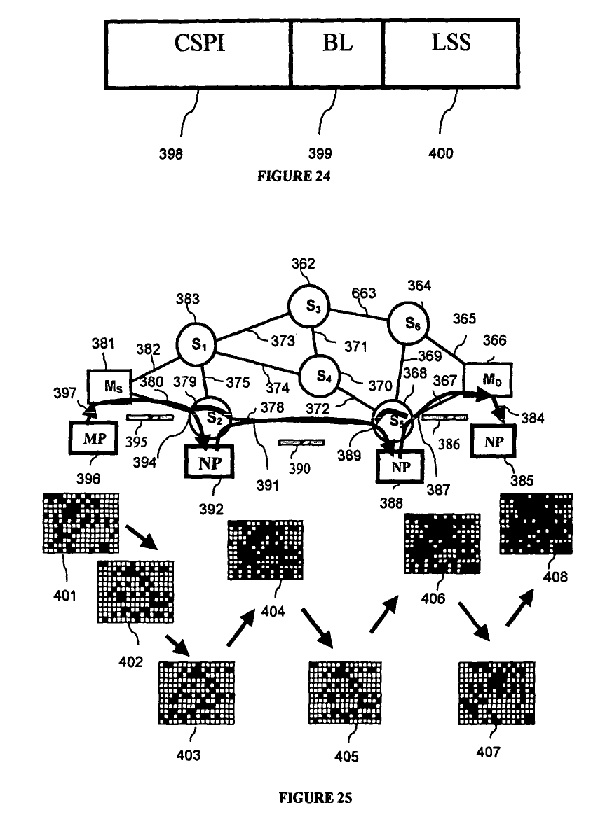

FIG. 24 shows the format of the LOSP connection-seeking packet (CSP). 398 is the connection seeking packet identifier (CSPI), 399 is the blocking link (BL) and 400 is the line of sight state (LSS). The CSP is encapsulated in an IP packet and transmitted from node to node along selected route. The CSP is updated at each node before it is retransmitted to the next adjacent node. The CSPI 398 is 56 bytes long and contains the source node identification (M_{S}), the destination node identification (M_{D}), selected route, VPNID, Priority, Bandwidth (BW), Time of request, and Blocking event register. The BL 399 is 4 bytes long. The BL identifies the “Most Blocking Link” encountered so far. The BL is used to eliminate the worst link in the event of blocking. The LSS 400 is 320 byes, or 2560 bits, one bit for each of 64 timeslots and colour combination. Bit=logic 0 indicates open timeslot and colour (waveslot) position. The CSP is originated at the source node 381 with the LSS having a full set of connection possibilities available and is updated at each intermediate switch node on the way to the destination node 366 by being logically OR'ed with the Link Sate at that node.

FIG. 25 illustrates how the LOSP identifies the open channels on the best route between source and destination points. The Line of sight link state matrix is progressively occluded as the CSP traverses the route from the source node 381 to the destination node 366. At each node the number of channels blocked is calculated and the blocking link field, BL, 399 in FIG. 24 is calculated and the field is updated if the new link is worst than other previous traversed links on the route.

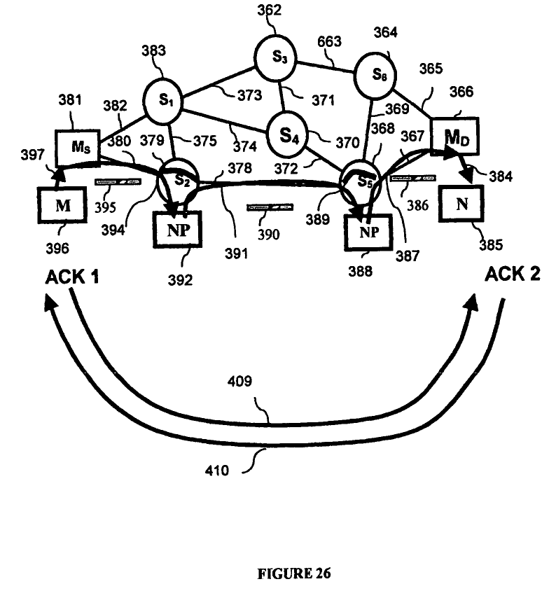

FIG. 26 illustrates how the channels are reserved for a connection. The destination node 366 randomly selects as many channels as indicated in the bandwidth (BW) field of the CSPI, 398 in FIG. 24. Node 366 then encapsulates the information into a Reservation request packet (RRP) 386 and transmits to the first switch node 368 on the reverse route. The switch node 368 reserves the channels for the connection. The first switch node 368 transmits an RRP 390 to the second switch node 379 on the route, and it likewise reserves channels for the connection. The source node 381 for the connection receives an RPP packet 395 from node 379 and sends an acknowledgement (ACK) packet 409 to the destination node 366. The destination node 366 in turn sends an acknowledgement (ACK) packet 410 to the destination node 381 and transmission on the connection path over fibers 380, 378 and 367 begins.

When the RRP arrives at a switch node, and the nodal processor at the node finds that the requested channels have been already taken, meaning a“colliding ” RRP got there, the nodal processor updates the “Line of Sight State” and returns the RRP to the destination node 366. The destination node then randomly selects new channels and launches anew RRP. The channels are reserved if possible, if not the destination node selects new channels and anew RRP is launched until an available path is found and a RRP arrives at the source node 381, and the channels are reserved along the path and the connection session can begin.

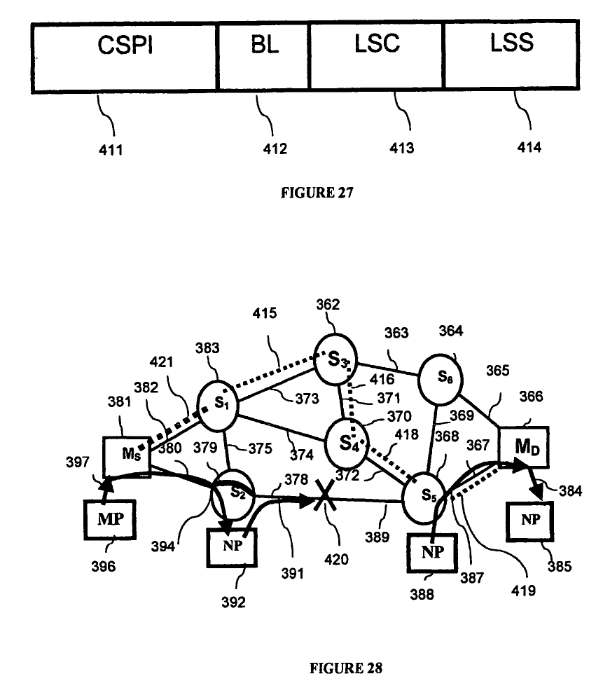

FIG. 27 shows the format of the LOSP reservation request packet (RRP). 411 is the connection seeking packet identifier (CSPI), 412 is the blocking link (BL), 413 is list of selected channels (LSC) and 414 is the line of sight state (LSS).

FIG. 28 is if the route is blocked because of a failure 420, the source node 381 eliminates the offending link(s) 378 from the node's topology map using the “blocking link field” 412 of FIG. 27. The management system re-calculates the Dijksta and then re-initiates the process with the next best route, in this case 421,415,416,418 and 419, through switch nodes 383,362,370 and 368 to the destination node 366.

What is claimed is:

1. An optical communication system having switch nodes and add/drop nodes, characterized in that data are switched and propagate through the system as optical bursts transmitted in waveslots of fixed duration and fixed positions in repetitive frames.

2. The optical communication system of claim 1, wherein said optical bursts have different predetermined combinations of wavelengths.

3. The optical communication system as defined in claim 2, wherein the data transmitted as optical bursts have rates lower than that of transmission rates between nodes.

4. The optical communication system of claim 1, wherein the switch nodes are photonic and route a repetitive frame in its entirety between input and output ports of a switch node.

5. The optical communication system of claims 2, wherein the switch nodes are photonic and route a repetitive frame in its entirety between input and output ports of a switch node.

6. The optical communication system of claim 3, wherein the switch nodes are photonic and route a repetitive frame in its entirety between input and output ports of a switch node.

7. The optical communication system of claim 3, wherein no two waveslots on a single transmission medium have optical bursts identical in wavelengths and timeslots.

8. The optical communication system of claim 7, wherein a plurality of transmission media carry a plurality of waveslots having identical wavelengths and timeslots propagating on separate transmission media.
